(19) United States
(12) Patent Application Publication
(10) Pub. No.: US 2023/0083660 A1
(43) Pub. Date: Mar. 16, 2023

(54) MALE MASTURBATION DEVICE

(71) Applicant: INNOVATION STREET PTE. LTD., Singapore (SG)

(72) Inventor: Praveen RAJU, Singapore (SG)

(21) Appl. No.: 17/471,874

(22) Filed: Sep. 10, 2021

(51) Int. Cl. A61H 19/00; A61H 23/00

(52) U.S. Cl. CPC A61H 19/32; A61H 23/00; A61H 2201/12; A61H 2201/1692

(57) ABSTRACT

A male masturbation device, includes a soft artificial colloid set in a housing which imitates the vagina, and a cavity is provided in the artificial colloid for accommodating the penis, a movement drive is provided along the housing and drives the artificial colloid to move along and stimulate the penis. The artificial colloid simulates the female vagina and when the movement drive drives the artificial colloid to move along the penis, it just likes a real sexual behavior. So that makes user experience a more realistic effect and better stimulate the male reproductive organs and achieve orgasm.

### FIELD OF THE INVENTION

The Utility Model involves a sex product, especially a mal masturbation device.

### BACKGROUND OF THE INVENTION

Masturbation has the merit of independent sexual behavior, and can obtain the same physiological response as sexual intercourse. Appropriate masturbation will not cause any harm to the body, but can also make up for people who cannot have sex in life, such as unmarried young people, separated husbands and wives, divorced widows, STD patients, disabled persons, and spouses who are sick and cannot have sex. And masturbation give them greater enthusiasm and energy for work. Further, masturbation can also be used to collect semen samples for clinical examination, and healthy men can also donate their own semen through masturbation. Masturbation will not cause any sexual infectious disease, will not involve others, or be involved in infidelity in sexual behavior and emotional entanglement, and will help to decrease sexual assault or even sexual crimes, and avoids moral and social problems caused by sexual problems. Therefore, masturbation is harmless. Do not have psychological pressure to avoid feelings of guilt and self-blame. But frequent masturbation may lead to lack of concentration, fatigue, and memory loss. Therefore, it is necessary to control the frequency and intensity of masturbation

In order to meet the demand of masturbation, there are masturbation devices for men on the market. Most of the existing male masturbators are made of soft rubber to simulate the female vagina and add a vibration function to produce a stimulating effect. However, due to the simple structure and relatively single function, it is difficult to imitate the various stimuli produced during human sexual behavior, so it is not ideal.

### SUMMARY OF THE UTILITY MODEL

In view of the aforesaid drawbacks of the prior art, the present utility model provides a male masturbation device to imitate the movement of female vagina, and let it feel more realistic when used, so as to better stimulate male reproductive organs and achieve orgasm.

So, the utility model provides:

A male masturbation device, wherein includes a soft artificial colloid set in a housing which imitates the vagina, and a cavity is provided in the artificial colloid for accommodating the penis, a movement drive is provided along the housing and drives the artificial colloid to move along and stimulate the penis.

Further, the movement drive includes a holder for removable fixing the top of the artificial colloid; the holder is connected with the movement drive.

Further, the guide structure for the movement of the holder is provided inside the housing, which includes a sliding rod and a sliding sleeve, they are respectively installed on the housing and the holder.

Further, magnets are embedded in the top of the artificial colloid and the holder.

Further, an ejector for detaching the artificial colloid with the holder is provided; the ejector is set in the holder and the handle of it extends to the bottom of the housing; when pulls the handle to let the ejector enter into the holder, the ejector push the top of the artificial colloid to separate the artificial colloid and the holder.

Further, the bottom of the housing is an opening, the cavity's entrance of the colloid extends to the outside of the opening and a buckle ring is provided to fix with the opening.

Further, the buckle ring and the opening provide with buckle and buckle hole for locking the colloid with the opening.

Further, a wrinkle massage section, a spiny massage section and a glans massage section are sequentially distributed in the inner wall of the cavity from the entrance.

Further, the movement drive is an eccentric structure, which includes a motor, an eccentric wheel and a shaft, the eccentric wheel is installed to the motor, the shaft is connects between the eccentric wheel and the holder.

The utility model has the following advantages: the artificial colloid simulates the female vagina and when the movement drive drives the artificial colloid to move along the penis, it just likes a real sexual behavior. So that makes user experience a more realistic effect and better stimulate the male reproductive organs and achieve orgasm.

### BRIEF DESCRIPTION OF THE DRAWINGS

Below are explanations of the invention combining with drawings.

FIG. 1 is the exploded view of the present utility model.

FIG. 2 is the bottom view of the housing.

FIG. 3 is the front view of the artificial colloid.

FIG. 4 is the A-A section view of FIG. 3.

In the figures: 1. the artificial colloid, 2. the housing, 3. the cavity, 4. the holder, 5. the sliding rod, 6. the sliding sleeve, 7. the magnets, 8. the ejector, 9. the handle, 10. the opening, 11. the buckle ring, 12. the buckle, 13. the buckle hole, 14. the wrinkle massage section, 15. the spiny massage section, 16. the glans massage section, 17. the motor, 18. the eccentric wheel, 19. the shaft.

### DESCRIPTION OF THE EMBODIMENTS

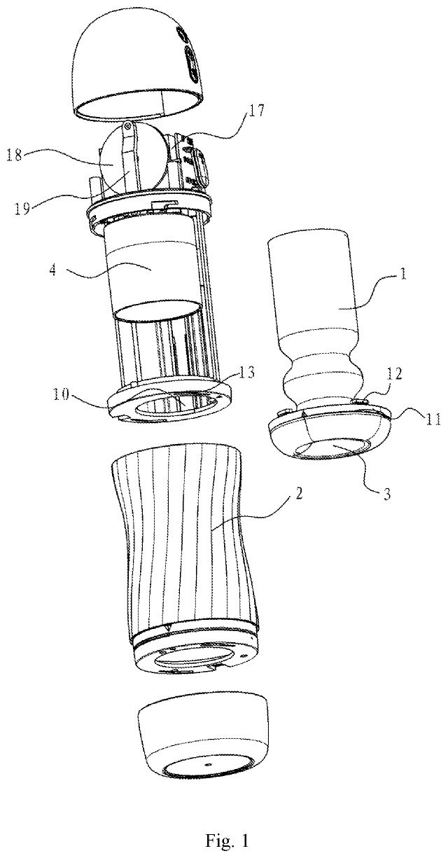

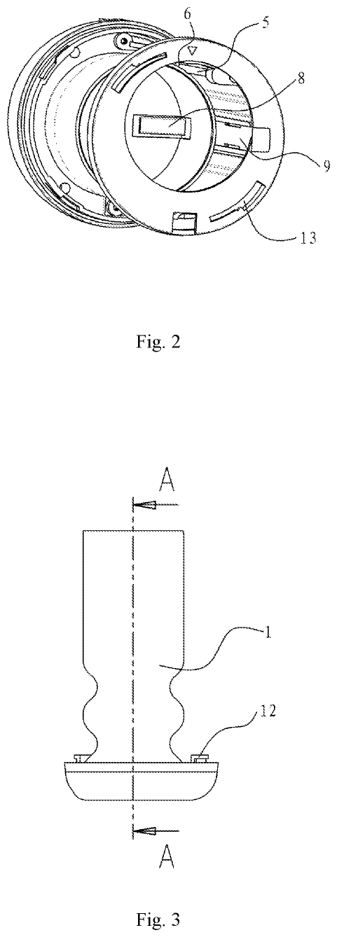

Refer to FIG. 1 and FIG. 2, the male masturbation device, includes a soft artificial colloid 1 set in a housing 2 which imitates the vagina, and a cavity 3 is provided in the artificial colloid 1 for accommodating the penis. The artificial colloid 1 generally uses the silicone which simulates the skin, to be solidified and formed by a mold. And it imitates the structure of a female vagina, making the artificial colloid 1 close to the female vagina by touch and practicality. A movement drive is also provided along the housing 2. It is connected with the artificial colloid 1 and drives the artificial colloid 1 to move along the penis, just likes the movement of female vaginal. So that makes user experience a more realistic effect and better stimulate the male reproductive organs and achieve orgasm.

The movement drive is an eccentric structure for converting rotation into sliding. It includes a motor 17, an eccentric wheel 18 and a shaft 19, the eccentric wheel 18 is installed to the motor 17, the shaft 19 is connects between the eccentric wheel 18 and the holder 4. The motor 17 drive the eccentric wheel 18 and make the shaft 19 pushing the holder 4 to slide along the housing 2.

To limit the move direction of the holder 4 and the colloid 1, a guide structure is provided inside the housing 2, which includes a sliding rod 5 and a sliding sleeve 6. They are respectively installed on the housing 2 and the holder 4.

In order to ensure the hygienic use of the colloid 1, the colloid 1 should be able to be easily taken out so that the user can clean and disinfect the colloid 1. And in order to facilitate above disassembly of the artificial colloid 1 from the housing 2 and easily taking out for cleaning, the colloid 1 must be removable with the movement drive. A holder 4 is set inside and can slide along the housing 2. The holder 4 connects to the movement drive and the colloid 1 connects to the holder 4. The removable structure between the holder 4 and the colloid 1 can be variety. The magnet structure is mostly preferred. That is magnets 7 are embedded in the top of the artificial colloid 1 and the holder 4, so when the colloid 1 is put into the holder 4, the magnets 7 will fix them up and let the colloid 1 move together with the holder 4. Also, the bottom of the housing 2 is provided with an opening 10, the cavity's entrance of the colloid 1 extends to the outside of the opening 10 and a buckle ring 11 is provided to fix it with the opening 10. Further, the buckle ring 11 and the opening 10 provide with buckle 12 and buckle hole 13 for locking the colloid 1 with the opening 10.

When the colloid 1 is needed to be disassembled for cleaning, user must pull the colloid 1 to let magnets 7 detached and take it out from the holder 4. As the colloid 1 is soft and tender, the pulling may destroy it. So an ejector 8 for detaching the artificial colloid 1 with the holder 4 is provided. It is set in the holder 4 and its handle 9 is extended to the bottom of the housing 2 for much more easily operation. When pulls the handle 9, the ejector 8 enters into the holder 4 and pushes the top of the artificial colloid 1. So the artificial colloid 1 and the holder 4 are separated.

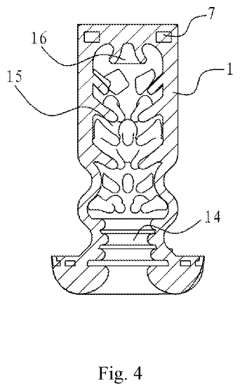

For better imitating the structure of the female vagina and improve the stimulation during use, a wrinkle massage section 14, a spiny massage section 15 and a glans massage section 16 are sequentially distributed in the inner wall of the cavity 3 from the entrance, refer to FIG. 3 and FIG. 4. During use, the different massage sections of the cavity 3 can provide different stimuli to different parts of the penis, so as to enhance the user experience.

1. A male masturbation device, wherein includes a soft artificial colloid set in a housing which imitates the vagina, and a cavity is provided in the artificial colloid for accommodating the penis, a movement drive is provided along the housing and drives the artificial colloid to move along and stimulate the penis.

2. The male masturbation device of claim 1, wherein the movement drive includes a holder for removable fixing the top of the artificial colloid; the holder is connected with the movement drive.

3. The male masturbation device of claim 1, wherein the guide structure for the movement of the holder is provided inside the housing, which includes a sliding rod and a sliding sleeve, they are respectively installed on the housing and the holder.

4. The male masturbation device of claim 2, wherein magnets are embedded in the top of the artificial colloid and the holder.

5. The male masturbation device of claim 4, wherein an ejector for detaching the artificial colloid with the holder is provided; the ejector is set in the holder and the handle of it extends to the bottom of the housing; when pulls the handle to let the ejector enter into the holder, the ejector push the top of the artificial colloid to separate the artificial colloid and the holder.

6. The male masturbation device of claim 1, wherein the bottom of the housing is an opening, the cavity's entrance of the colloid extends to the outside of the opening and a buckle ring is provided to fix with the opening.

7. The male masturbation device of claim 6, wherein the buckle ring and the opening provide with buckle and buckle hole for locking the colloid with the opening.

8. The male masturbation device of claim 6, wherein a wrinkle massage section, a spiny massage section and a glans massage section are sequentially distributed in the inner wall of the cavity from the entrance.

9. The male masturbation device of claim 6, wherein the movement drive is an eccentric structure, which includes a motor, an eccentric wheel and a shaft, the eccentric wheel is installed to the motor, the shaft is connects between the eccentric wheel and the holder.
